(19) United States
(12) Patent Application Publication
(10) Pub. No.: US 2023/0371510 A1
(43) Pub. Date: Nov. 23, 2023

(54) APPLICATION OF PYRROLE-2-CARBOXALDEHYDE IN CONTROLLING PLANT ROOT-KNOT NEMATODES

(71) Applicant: Yunnan University, Kunming (CN)

(72) Inventors: Peiji ZHAO, Kunming (CN); Keqin ZHANG, Kunming (CN); Minghe MO, Kunming (CN); Guohong LI, Kunming (CN); Zhengxue BAO, Kunming (CN)

(21) Appl. No.: 18/319,220

(22) Filed: May 17, 2023

(30) Foreign Application Priority Data
May 17, 2022 (CN) 2022105403569

(51) Int. Cl. A01N 43/36; A01P 5/00; A01N 25/04

(52) U.S. Cl. CPC A01N 43/36; A01P 5/00; A01N 25/04

(57) ABSTRACT

The present invention relates to the technical field of agricultural pest control, and more particularly, to the application of pyrrole-2-carboxaldehyde in controlling plant root-knot nematodes. Pyrrole-2-carboxaldehyde and agronomically acceptable salts thereof have strong insecticidal activity against root-knot nematodes. Pyrrole-2-carbaldehyde shows the advantages of high efficiency, low toxicity and low residue compared to other insecticides and is more compatible with the environment, which meets the needs of green plant protection and sustainable agricultural production and development.

### FIELD OF THE INVENTION

The present invention relates to the technical field of agricultural pest control, and more particularly, to the application of pyrrole-2-carboxaldehyde in controlling plant root-knot nematodes.

### BACKGROUND OF THE INVENTION

Root-knot nematodes are serious pests that not only bring serious diseases to human beings and animals but also cause losses equivalent to $104.4 billion to crops every year. Of the common plant pathogenic nematodes, Meloidogyne is the most harmful to plants, among which four species of Meloidogyne incognita, Meloidogyne arenaria, Meloidogyne hapla, Meloidogyne javanica are more common. Currently, chemical control is still the mainstay of nematode control, but most chemical nematicides are highly toxic and high-persistent pesticides, which pose a serious threat to humans, animals and the environment. In particular, some chemical nematicides, such as bromomethane used as a soil fumigant, have been banned in most countries around the world or have been given deadlines for use. Recent years have witnessed an enhancement in people's environmental awareness and a restriction on the use of chemical nematicides, research into root-knot nematodes has naturally become a priority and a focal point. In the research of biocontrol of nematodes, the first generation of commercial biocontrol agents directly using bacteria have been introduced and applied in a considerable range of fields. Despite this, this generation of products is a live bacterium and there are varying degrees of inhibition in the soil, resulting in unstable effects on different soils in different countries. This is a common problem of living biocontrol agents. In response to this, more attention has been paid to the development of the second generation of nematode biocontrol products, i.e., the R&D of secondary metabolites of strains.

Pyrrole-2-carboxaldehyde, also known as 2-Pyrrolecarbaldehyde or 1H-Pyrrole-2-carbaldehyde or 2-Formyl-1H-pyrrole, is a precursor of organic synthesis of drugs and can be used as a flavoring agent in the food industry. However, there are no published literature reports on the nematoidal activity of 2-Pyrrolecarbaldehyde and its application in preparing nematicidal preparations.

### DESCRIPTION OF THE INVENTION

The main object of the present invention is to provide the application of pyrrole-2-carboxaldehyde in controlling plant root-knot nematodes. The present invention finds for the first time that pyrrole-2-carboxaldehyde has the function of poisoning root-knot nematodes with remarkable effects.

To achieve the above object, the present invention provides the following technical solution:

The present invention provides an application of pyrrole-2-carboxaldehyde and/or agronomically acceptable salts thereof in controlling plant root-knot nematodes and reveals their potent insecticidal activity against root-knot nematodes.

Said plant root-knot nematodes include but are not limited to Meloidogyne incognita, Meloidogyne hapla, Meloidogyne javanica or Meloidogyne arenaria.

The present invention also provides a composition for controlling plant root-knot nematodes, which comprises pyrrole-2-carboxaldehyde and/or agronomically acceptable salts thereof.

Further, said composition also includes fatty alcohol and water.

And further, the mass concentration of pyrrole-2-carboxaldehyde and/or agronomically acceptable salts thereof is ≥30 g/ml, and that of fatty alcohol is ≤5%.

Furthermore, said fatty alcohol includes but is not limited to methanol, ethanol and propanol.

The present invention also provides the application of the composition in preparing insecticides for controlling plant root-knot nematodes.

Further, said insecticides are available in the dosage forms of the aqueous solution, emulsion in water, wettable powder, soluble powder, soluble granule, water dispersible granule, suspending agent, oil suspending agent, tablet and effervescent granule.

Compared with the prior art, the present invention has the following advantages: The present invention finds for the first time that pyrrole-2-carboxaldehyde and agronomically acceptable salts thereof exhibit strong insecticidal activity against root-knot nematodes, with LC₅₀ concentrations of 84.725 μg/ml at 24 h and 30.733 μg/ml at 48 h against Meloidogyne incognita.

Pyrrole-2-carboxaldehyde, derived from microorganisms and plants, is a common industrial raw material that degrades easily in the environment. It shows the advantages of high efficiency, low toxicity and low residue compared to other insecticides to root-knot nematode and is more compatible with the environment, which meets the needs of green plant protection and sustainable agricultural production and development.

### DETAILED DESCRIPTION OF THE PREFERRED EMBODIMENTS

It is to be understood that the following detailed description is exemplary and explanatory and is intended to provide further explanation of the invention as claimed. Unless otherwise defined, all technical and scientific terms used herein have the same meaning as commonly understood by one of ordinary skill in the art to which the present invention pertains.

It is also to be understood that the terminology used herein is for the purpose of describing particular embodiments only, and is not intended to be limiting. As used herein, the singular forms “a”, “an”, and “the” include plural references unless the context clearly dictates otherwise. It should also be understood that the terms “comprises” and “comprising”, when used in this specification, are taken to specify the presence of stated features, steps, operations and combinations thereof.

To enable those skilled in the art to understand the technical scheme of the invention more clearly, the technical scheme of the invention will be described in detail below in relation to specific embodiments.

### Example 1

1. Sample Preparation

0.5 mg-1.5 mg of pyrrole-2-carboxaldehyde was dissolved in methanol and diluted with sterile distilled water as the test liquid. The dilution concentrations of each liquid medicine were 12.5 μg/ml, 25 μg/ml, 50 μg/ml, 100 μg/ml, 200 μg/ml and 400 μg/ml respectively, and the mass concentration of methanol in each liquid medicine was 5%. Water containing 5% methanol was used as a blank control.

2. Preparation of Nematodes for Testing.

The infected tomato roots with Meloidogyne incognita were washed with water, and the oocysts of Meloidogyne incognita were picked by a dissecting needle and placed in 0.4 M KCl solution. The oocysts were washed and disinfected in a 5 ml centrifuge tube with 4 ml sterile water (three times), 1 ml sterile penicillin-streptomycin double antibody solution and 3 ml 0.1% NaClO solution, and the supernatant was removed in each step by short centrifugation (8000 rpm for 30 seconds). The washed eggs were incubated in 0.4 M ZnCl₂ solution for 48 h, and the second instar larvae were collected in a 1.5 ml centrifuge tube with a pipette and enriched by short centrifugation (5000 rpm for 30 seconds) for subsequent use.

In addition, root-knot nematodes such as Meloidogyne hapla, Meloidogyne javanica and Meloidogyne arenaria were also prepared for testing.

3. Test Methods

200 μl of the above test liquid was added to a 20-well plate with 100-150 live nematodes and placed at 25° C. Subsequently, the nematodes were examined under an optical microscope at 12 h, 24 h and 48 h, respectively, to calculate the mortality. Method for identification of mortality: 1-5 drops of 5% NaCl solution were added to the wells of the treatment plate and observed after 2 minutes; Dead nematodes were stiff and unresponsive to stimulation with a needle, while surviving nematodes were curled or wriggled.

The whole experiment was repeated three times with the test liquid without samples as the control, and the average value was taken three times to calculate the corrected mortality.

Mortality %=(number of dead nematodes/(number of dead nematodes+number of surviving nematodes))×100%

Corrected mortality %=sample mortality−control mortality

4. Experimental Results

The insecticidal effects of pyrrole-2-carboxaldehyde against Meloidogyne incognita are shown in Tables 1 and 2 below:

TABLE 1
Insecticidal results of pyrrole-2-carboxaldehyde
against Meloidogyne incognita (%)

| Liquid | | | | | |
|---|---|---|---|---|---|
| concentration | Corrected mortality (%) | | | | |
| Unit (μg/ml) | 12 h | 24 h | 36 h | 48 h | 72 h |
| 400 | 47.50 ± 4.35 | 77.42 ± 0.58 | 93.20 ± 0.82 | 98.01 ± 0.20 | 99.26 ± 0.34 |
| 200 | 34.23 ± 1.74 | 64.27 ± 0.90 | 79.29 ± 0.70 | 93.27 ± 2.24 | 94.51 ± 1.89 |
| 100 | 24.29 ± 2.78 | 38.74 ± 2.00 | 62.03 ± 0.85 | 83.24 ± 1.29 | 88.27 ± 0.56 |
| 50 | 22.37 ± 0.43 | 36.63 ± 0.19 | 53.41 ± 3.16 | 56.60 ± 0.63 | 63.22 ± 0.99 |
| 25 | 15.84 ± 0.29 | 26.50 ± 0.53 | 36.30 ± 0.95 | 42.14 ± 1.51 | 48.51 ± 0.78 |
| 12.5 | 6.99 ± 1.99 | 16.60 ± 3.58 | 24.95 ± 4.70 | 30.27 ± 4.57 | 36.08 ± 5.08 |

TABLE 2
Calculated results of the toxicity assay of pyrrole-
2-carboxaldehyde against Meloidogyne incognita (%)

| Calculation | Time | | LC₅₀ | |
|---|---|---|---|---|
| method | (h) | Regression equation | (μg/ml) | 95% CI |
| SPSS 26.0 | 24 | y = −2.648 ± 1.373x | 84.725 | 44.990-181.818 |
| SPSS 26.0 | 48 | y = −2.488 ± 1.627x | 30.733 | 22.625-39.506 |

The results showed that the LC₅₀ concentrations of pyrrole-2-carboxaldehyde against Meloidogyne incognita were 84.725 μg/ml at 24 h and 30.733 μg/ml at 48 h.

The LC₅₀ concentrations of pyrrole-2-carboxaldehyde against Meloidogyne hapla, Meloidogyne incognita, Meloidogyne javanica and Meloidogyne arenaria were 31.635 μg/ml, 33.589 μg/ml and 30.967 μg/ml, respectively, at 48 h. It can be seen that pyrrole-2-carboxaldehyde has an insecticidal effect on plant root-knot nematodes.

### Example 2

A composition for preventing and controlling plant root-knot nematodes, which comprises pyrrole-2-carboxaldehyde 30 μg/ml, ethanol with a mass concentration of 3% and water as a solvent.

Said composition can be made into the aqueous solution and emulsion-in-water insecticide together with other conventional pesticide adjuvants.

### Example 3

A composition for controlling plant root-knot nematodes, which comprises 4-bromothiophene-2-carboxaldehyde 30 μg/ml, ethanol with a mass concentration of 3% and water as a solvent.

Said composition can be made into aqueous solution and emulsion-in-water insecticide together with other conventional pesticide adjuvants.

The above-mentioned embodiments are preferred embodiments of the present invention, but the embodiments of the present invention are not limited by the above-mentioned embodiments. Any other changes, modifications, substitutions, combinations and simplifications made without departing from the spirit and principle of the present invention should be constructed as equivalents thereof, which are all included in the protection scope of the present invention.

What is claimed is:

1. Application of pyrrole-2-carboxaldehyde and/or agronomically acceptable salts thereof in controlling plant root-knot nematodes.

2. A composition for controlling plant root-knot nematodes, characterized in that it comprises pyrrole-2-carboxaldehyde and/or agronomically acceptable salts thereof.

3. The composition for controlling plant root-knot nematodes according to claim 2, characterized in that it further comprises fatty alcohol and water.

4. The composition for controlling plant root-knot nematodes according to claim 3, characterized in that the mass concentration of pyrrole-2-carboxaldehyde and/or agronomically acceptable salts thereof is ≥30 g/ml, and that of fatty alcohol is ≤5%.

5. The composition for controlling plant root-knot nematodes according to claim 3 or claim 4, characterized in that said fatty alcohol comprises methanol, ethanol and propanol.

6. Application of the composition according to any one of claims 2-5 in preparing insecticides for controlling plant root-knot nematodes.

7. The application according to claim 6, characterized in that said insecticides are available in the dosage forms of the aqueous solution, emulsion in water, wettable powder, soluble powder, soluble granules, water dispersible granule, suspending agent, oil suspending agent, tablet and effervescent granule.
